(19) United States
(12) Patent Application Publication
(10) Pub. No.: US 2020/0410764 A1
(43) Pub. Date: Dec. 31, 2020

(54) REAL-TIME AUGMENTED-REALITY COSTUMING

(71) Applicant: Snap Inc., Santa Monica, CA (US)

(72) Inventors: Piers Cowburn, London (GB); Isac Andreas Müller Sandvik, London (GB); Qi Pan, London (GB); David Li, London (GB)

(21) Appl. No.: 16/457,541

(22) Filed: Jun. 28, 2019

(51) Int. Cl. G06T 19/00; G06F 3/0481; H04W 4/021; G06K 9/00

(52) U.S. Cl. CPC G06T 19/006; G06K 9/00362; H04W 4/021; G06F 3/04815

(57) ABSTRACT

An augmented-reality costume system for performing operations that include: causing display of a presentation of image data at a first client device; detecting a second client device in proximity with the first client device based on location data from the second client device, the second client device associated with a user profile that comprises user profile data; identifying a display of an object at a position within the presentation of the image data based on the location data from the client device, the display of the object comprising image features; accessing the user profile data from the user profile associated with the second client device, the user profile data comprising AR content; and presenting the AR content within the presentation of the image data at the first client device based on at least the position of the object within the presentation of the image data.

### TECHNICAL FIELD

Embodiments of the present disclosure relate generally to Augmented-Reality (AR) media, and more particularly, to systems to generate and present AR media.

### BACKGROUND

Augmented reality (AR) is an interactive experience of a real-world environment where the objects that reside in the real-world environment are enhanced by computer-generated perceptual information, sometimes across multiple sensory modalities. The overlaid sensory information (i.e., media content) can be constructive (i.e., additive to the natural environment) or destructive (i.e., masking of the natural environment) and is seamlessly interwoven with the physical world such that it is perceived as an immersive aspect of the real-world environment.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example messaging system for exchanging data (e.g., messages and associated content) over a network in accordance with some embodiments, wherein the messaging system includes an AR costume system.

FIG. 2 is block diagram illustrating further details regarding a messaging system, according to example embodiments.

FIG. 3 is a block diagram illustrating various modules of an AR costume system, according to certain example embodiments.

FIG. 4 is a flowchart illustrating a method for presenting AR content at a client device, according to certain example embodiments.

FIG. 5 is a flowchart illustrating a method for presenting AR content at a client device, according to certain example embodiments.

FIG. 6 is a flowchart illustrating a method for generating AR content, according to certain example embodiments.

FIG. 7 is a diagram illustrating AR content presented in a graphical user interface, according to certain example embodiments.

FIG. 8 is a diagram depicting a geo-fence for presenting AR content, according to certain example embodiments.

FIG. 9 is a block diagram illustrating a representative software architecture, which may be used in conjunction with various hardware architectures herein described and used to implement various embodiments.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

As discussed above. AR is an interactive experience of a real-world environment where the objects that reside in the real-world environment may be enhanced through the addition of computer-generated perceptual information, sometimes across multiple sensory modalities. The overlaid sensory information (i.e., media content) may be additive to the natural environment through the addition of media content, or destructive to the natural environment by masking of the natural environment. Accordingly, the AR media is seamlessly interwoven with the physical world such that it is perceived as an immersive aspect of the real-world environment.

In accordance with some embodiments described herein, an AR costume system may be or include any instrumentality or aggregate of instrumentalities operable to compute, process, store, display, generate, communicate, or apply various forms of data for performing operations that include: causing display of a presentation of image data at a first client device; detecting a second client device in proximity with the first client device based on location data from the second client device, the second client device associated with a user profile that comprises user profile data; identifying a display of an object at a position within the presentation of the image data based on the location data from the client device, the display of the object comprising image features; accessing the user profile data from the user profile associated with the second client device, the user profile data comprising AR content; and presenting the AR content within the presentation of the image data at the first client device based on at least the position of the object within the presentation of the image data.

In some embodiments, presenting the AR content within the presentation of the image data may include applying the AR content to the object based on the image features of the display of the object. For example, according to certain embodiments, the AR content may include a digital “costume,” or “skin,” wherein the digital costume is applied to a display of a person within a presentation of image data at a client device. Thus, from the perspective of a display of the client device, the person may appear to be dressed in the digital costume, such that the digital costume tracks movements and a position of the person within the presentation of the image data.

In some embodiments, the AR content may include AR content that modifies characteristics and attributes of a display of an object. For example, the AR content may alter the display of the object by scaling a size of the display of the object, changing proportions of the display of the object, as well as altering features of the display of the object. As an illustrative example, in an instance where the “object” includes a person, the AR content may change proportions of the display of the person, such that it appears as though the persons head is much larger or smaller than it actually is, or that the persons hair and skin are a different color.

In some embodiments, the AR content of the user profile associated with the second client device may be generated based on user profile data from the user profile, and a plurality of location attributes associated with a location. For example, a location may be associated with a geo-fence. Responsive to detecting a client device within the geo-fence, the AR costume system accesses a user profile associated with the client device to retrieve user profile data (e.g., user preferences, user demographics data, user attributes), and generates the AR content based on the user profile data and one or more predefined conditions associated with the geo-fence. For example, the conditions may define features of media content based on user attributes (i.e., “user attribute A” correlates with “media feature A”). The AR content is associated with the user profile of the client device by the AR costume system.

In certain example embodiments discussed herein, the AR costume system may employ computer vision and image processing techniques for the purposes of object detection, and more specifically, in order to detect semantic features of objects in digital images and videos. Accordingly, the AR costume system may detect one or more semantic features of an object depicted in image data and generate an AR costume based on at least the one or more semantic features of the object.

In some embodiments, a user profile associated with a client device may include user profile information that defines identifying characteristics, such as image features. For example, a display of an object within a presentation of image data may have corresponding image features.

Responsive to detecting the object, the AR costume system may analyze the image features of the object in order to identify a user profile that corresponds with the object. The image features may for example define a size of the object, facial recognition features, as well as body proportions.

In some embodiments, responsive to detecting a client device within a geo-fence, the AR costume system may cause display of a request at the client device, wherein the request includes a set of AR costumes, and AR costume options. A user of the client device may provide inputs selecting an AR costume and one or more AR costume options in order to generate and associate an AR costume with the user account associated with the client device.

Consider the following illustrative example from the perspective of a first client device. A user of the first client device may display image data captured by a camera of the first client device, within an interface of the first client device. A second client device associated with a second user is detected by the AR costume system in the proximity of the first client device (e.g., by a geo-fence). Responsive to detecting the second client device in the proximity of the first client device, the AR costume system accesses location data from the second client device. Based on the image data and the location data from the second client device, the AR costume system may then detect an object that corresponds with the second client device based on image features of a display of the object within the presentation of the image data.

The AR costume system may then apply an AR costume to the object based on the user profile associated with the second user device. For example, the AR costume may be a space-suit, such that the second user appears in the presentation of the image data at the first client device in a space suit.

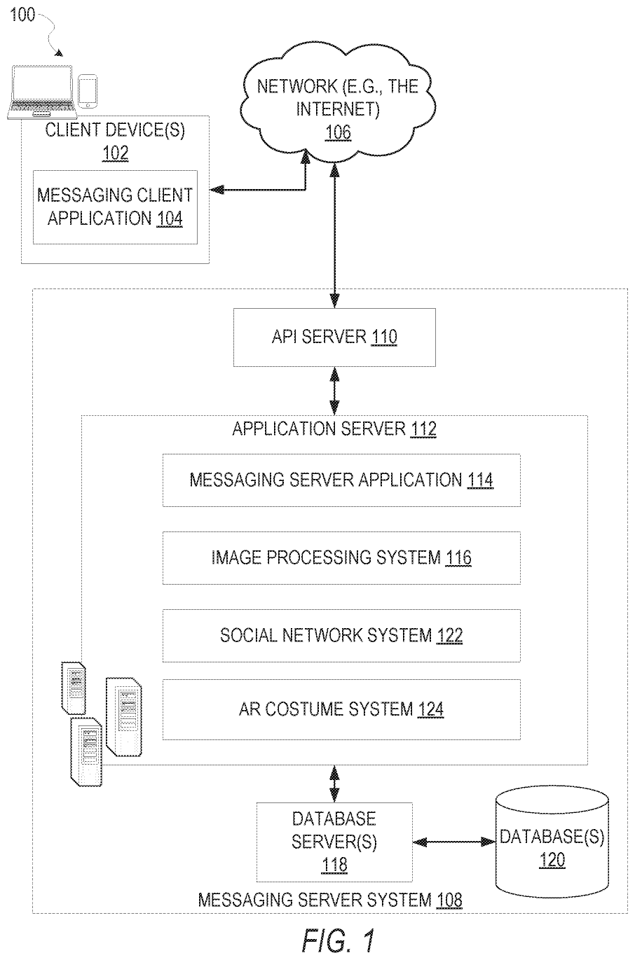

FIG. 1 is a block diagram showing an example messaging system 100 for exchanging data (e.g., messages and associated content) over a network. The messaging system 100 includes multiple client devices 102, each of which hosts a number of applications including a messaging client application 104. Each messaging client application 104 is communicatively coupled to other instances of the messaging client application 104 and a messaging server system 108 via a network 106 (e.g., the Internet).

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality either within the messaging client application 104 or the messaging server system 108 is a design choice. For example, it may be technically preferable to initially deploy certain technology and functionality within the messaging server system 108, but to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. In some embodiments, this data includes, message content, client device information, geolocation information, media annotation and overlays, message content persistence conditions, social network information, and live event information, as examples. In other embodiments, other data is used. Data exchanges within the messaging system 100 are invoked and controlled through functions available via GUIs of the messaging client application 104.

Turning now specifically to the messaging server system 108, an Application Program Interface (API) server 110 is coupled to, and provides a programmatic interface to, an application server 112. The application server 112 is communicatively coupled to a database server 118, which facilitates access to a database 120 in which is stored data associated with messages processed by the application server 112.

Dealing specifically with the Application Program Interface (API) server 110, this server receives and transmits message data (e.g., commands and message payloads) between the client device 102 and the application server 112. Specifically, the Application Program Interface (API) server 110 provides a set of interfaces (e.g., routines and protocols) that can be called or queried by the messaging client application 104 in order to invoke functionality of the application server 112. The Application Program Interface (API) server 110 exposes various functions supported by the application server 112, including account registration, login functionality, the sending of messages, via the application server 112, from a particular messaging client application 104 to another messaging client application 104, the sending of media files (e.g., images or video) from a messaging client application 104 to the messaging server application 114, and for possible access by another messaging client application 104, the setting of a collection of media data (e.g., story), the retrieval of a list of friends of a user of a client device 102, the retrieval of such collections, the retrieval of messages and content, the adding and deletion of friends to a social graph, the location of friends within a social graph, opening and application event (e.g., relating to the messaging client application 104).

The application server 112 hosts a number of applications and subsystems, including a messaging server application 114, an image processing system 116, a social network system 122, and an AR costume system 124. The messaging server application 114 implements a number of message processing technologies and functions, particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories, galleries, or collections). These collections are then made available, by the messaging server application 114, to the messaging client application 104. Other processor and memory intensive processing of data may also be performed server-side by the messaging server application 114, in view of the hardware requirements for such processing.

The application server 112 also includes an image processing system 116 that is dedicated to performing various image processing operations, typically with respect to images or video received within the payload of a message at the messaging server application 114.

The social network system 122 supports various social networking functions services and makes these functions and services available to the messaging server application 114. To this end, the social network system 122 maintains and accesses an entity graph 304 within the database 120. Examples of functions and services supported by the social network system 122 include the identification of other users of the messaging system 100 with which a particular user has relationships or is “following,” and also the identification of other entities and interests of a particular user.

The application server 112 is communicatively coupled to a database server 118, which facilitates access to a database 120 in which is stored data associated with messages processed by the messaging server application 114.

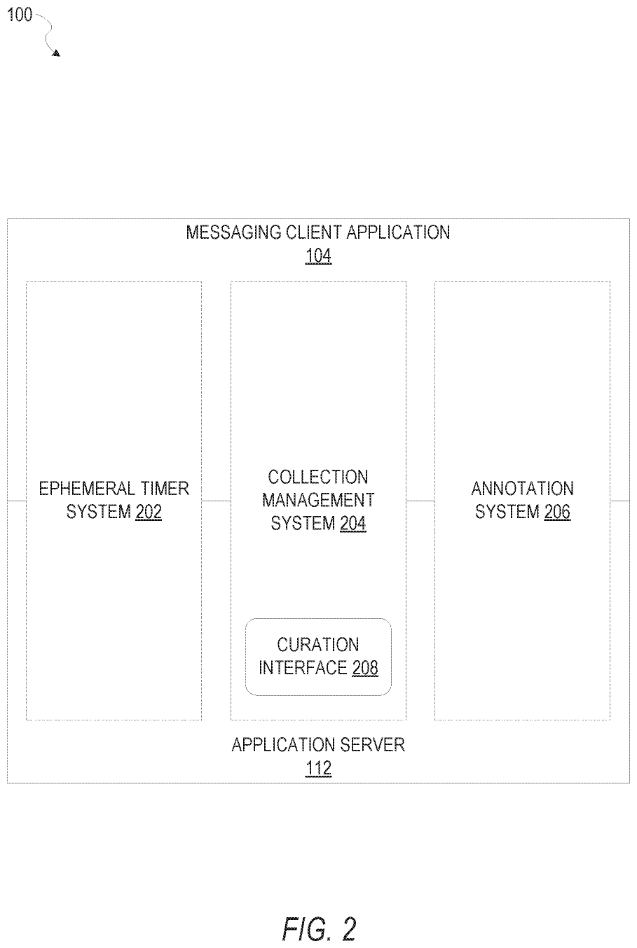

FIG. 2 is block diagram illustrating further details regarding the messaging system 100, according to example embodiments. Specifically, the messaging system 100 is shown to comprise the messaging client application 104 and the application server 112, which in turn embody a number of some subsystems, namely an ephemeral timer system 202, a collection management system 204 and an annotation system 206.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message, collection of messages, or graphical element, selectively display and enable access to messages and associated content via the messaging client application 104. Further details regarding the operation of the ephemeral timer system 202 are provided below.

The collection management system 204 is responsible for managing collections of media (e.g., a media collection that includes collections of text, image video and audio data). In some examples, a collection of content (e.g., messages, including images, video, text and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user generated content into a collection. In such cases, the curation interface 208 operates to automatically make payments to such users for the use of their content.

The annotation system 206 provides various functions that enable a user to annotate or otherwise modify or edit media content, such as user support content received by the user to be forwarded or redistributed to one or more recipients. For example, the annotation system 206 provides functions related to the generation and publishing of media overlays for messages processed by the messaging system 100. The annotation system 206 operatively supplies a media overlay to the messaging client application 104 based on a geolocation of the client device 102. In another example, the annotation system 206 operatively supplies a media overlay to the messaging client application 104 based on other information, such as, social network information of the user of the client device 102. A media overlay may include audio and visual content and visual effects, as well as augmented reality overlays. Examples of audio and visual content include pictures, texts, logos, animations, and sound effects, as well as animated facial models, image filters, and augmented reality media content. An example of a visual effect includes color overlaying. The audio and visual content or the visual effects can be applied to a media content item (e.g., a photo or video or live stream) at the client device 102. For example, the media overlay including text that can be overlaid on top of a photograph generated taken by the client device 102. In another example, the media overlay includes an identification of a location overlay (e.g., Venice beach), a name of a live event, or a name of a merchant overlay (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map, and upload content associated with the selected geolocation. The user may also specify circumstances under which a particular media overlay should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation. For example, the annotation system 206 associates the media overlay of a highest bidding merchant with a corresponding geolocation for a predefined amount of time

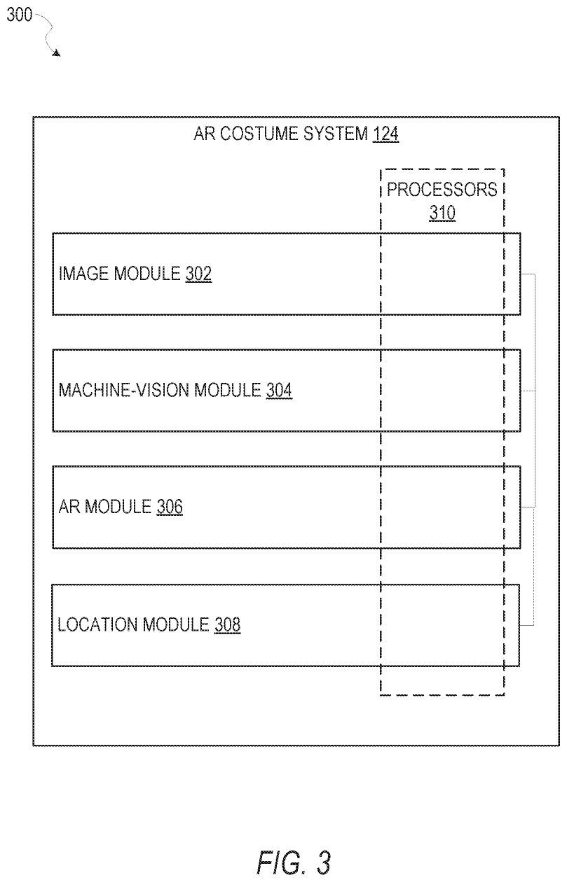

FIG. 3 is a block diagram illustrating components of the AR costume system 124 that configure the AR costume system 124 to perform operations to detect people within a presentation of image data at a first client device 102, identify user profiles that correspond to the people detected within the presentation of the image data, access AR content associated with the user profiles, and presenting the AR content as an AR costume within the presentation of the image data at the first client device 102, according to certain example embodiments.

The AR costume system 124 is shown as including an image module 302, a machine-vision module 304, an AR module 306, and a location module 308, all configured to communicate with each other (e.g., via a bus, shared memory, or a switch). Any one or more of these modules may be implemented using one or more processors 310 (e.g., by configuring such one or more processors to perform functions described for that module) and hence may include one or more of the processors 310.

Any one or more of the modules described may be implemented using hardware alone (e.g., one or more of the processors 310 of a machine) or a combination of hardware and software. For example, any module described of the AR costume system 124 may physically include an arrangement of one or more of the processors 310 (e.g., a subset of or among the one or more processors of the machine) configured to perform the operations described herein for that module. As another example, any module of the AR costume system 124 may include software, hardware, or both, that configure an arrangement of one or more processors 310 (e.g., among the one or more processors of the machine) to perform the operations described herein for that module. Accordingly, different modules of the AR costume system 124 may include and configure different arrangements of such processors 310 or a single arrangement of such processors 310 at different points in time. Moreover, any two or more modules of the AR costume system 124 may be combined into a single module, and the functions described herein for a single module may be subdivided among multiple modules. Furthermore, according to various example embodiments, modules described herein as being implemented within a single machine, database, or device may be distributed across multiple machines, databases, or devices.

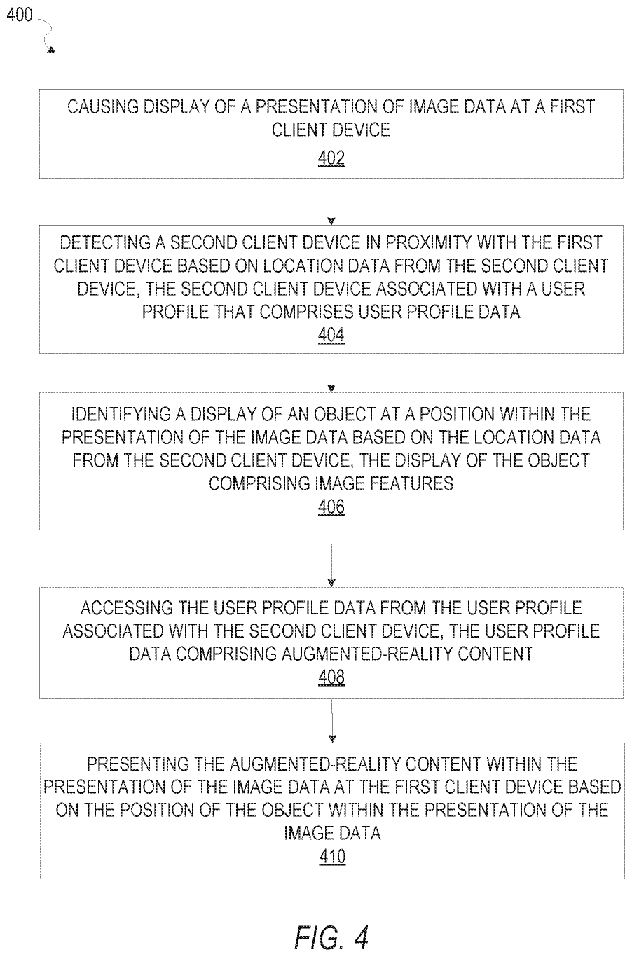

FIG. 4 is a flowchart illustrating a method 400 for presenting AR content at a client device 102, according to certain example embodiments. Operations of the method 400 may be performed by the modules described above with respect to FIG. 3. As shown in FIG. 4, the method 400 includes one or more operations 402, 404, 406, 408, and 410.

At operation 402, the image module 302 causes display of a presentation of image data at a first client device 102. The image data may comprise a data stream of image and video data captured by a camera associated with the first client device 102. For example, the first client device 102 may include a camera configured to generate and stream the image data.

At operation 404, the location module 308 detects a second client device 102 in proximity with the first client device 102 based on location data from the first client device 102 and the second client device 102. For example, in some embodiments, responsive to the image module 302 causing display of the presentation of the image data at the first client device 102, the location module 308 may identify one or more client devices in proximity with the first client device 102, based on location data from the first client device 102. Accordingly, the location module 308 may identify the one or more client devices based on a threshold distance from a location of the first client device 102, wherein the threshold distance is defined based on user preferences or based on a geo-fence.

At operation 406, the machine-vision module 304 identifies a display of an object at a position within the presentation of the image data at the first client device 102, based on the location data from the second client device 102, wherein the display of the object comprises a set of image features.

For example, the machine-vision module 304 may receive location data from the first client device 102 and the second client device 102, where the location data identifies locations of the first and second client devices. For example, the machine-vision module 304 identifies one or more objects within the presentation of the image data at the first client device 102 and using the location data from the first client device 102 as a reference point, correlates an object from among the one or more objects to the second client device 102 based on the location data from the second client device 102.

In some embodiments, the machine-vision module 304 may identify an object that corresponds with the second client device 102 based on the image features of the object. For example, the second client device 102 may be associated with a user profile, wherein the user profile comprises user profile data that includes identifying features (i.e., the image data). Upon detecting the object within the presentation of the image data at the first client device 102, the machine-vision module 304 may query a database, such as the database 120, based on the image features in order to identify the user profile associated with the second client device 102. The image features may for example include facial recognition features, as well as body proportions.

At operation 408, the AR module 306 accesses a user profile associated with the second client device 102, in response to the machine-vision module 304 detecting the object that corresponds with the second client device 102. The user profile associated with the second client device 102 may include AR content, and a set of user attributes and preferences that may define AR content.

In some embodiments, a user may generate and associate AR content with a user profile based on user inputs. For example, the AR costume system 124 may present an AR content configuration interface to the user, wherein the AR content configuration interface comprises a set of selections to define the AR content.

In some embodiments, the AR module 306 may generate the AR content on-the-fly, and in real-time, based on the user attributes and user preferences associated with the user profile. For example, the AR content may be generated based on one or more user preferences, user attributes, and contextual data (e.g., age, location, time or day, season, gender, hair color, eye color, etc.).

At operation 410, the AR module 306 presents the AR content associated with the second client device 102 within the presentation of the image data at the first client device 102, based on the position of the object that corresponds with the second client device 102 within the presentation of the image data, and the image features of the display of the object.

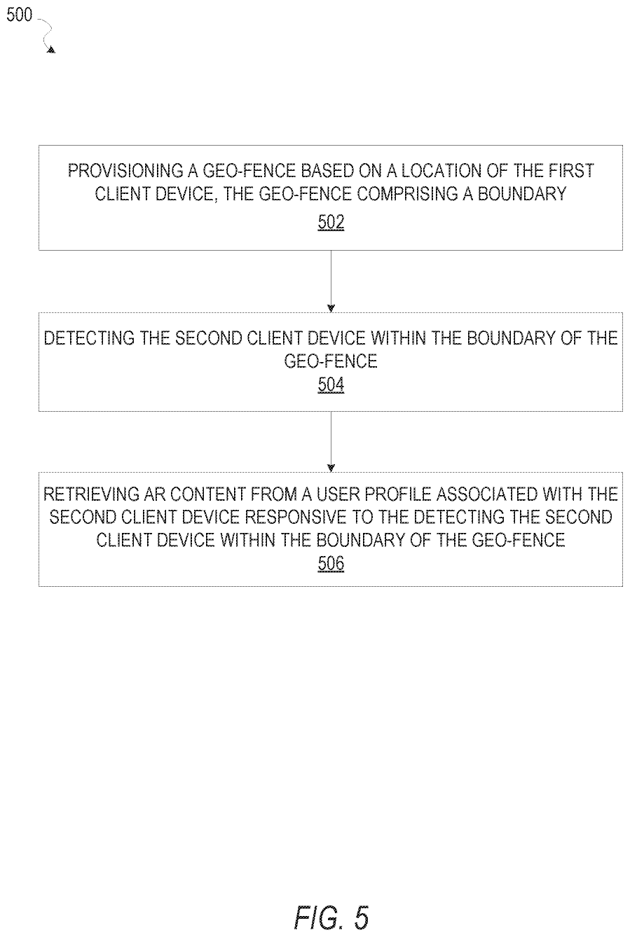

FIG. 5 is a flowchart illustrating a method 500 for presenting AR content at a client device 102, according to certain example embodiments. Operations of the method 500 may be performed by the modules described above with respect to FIG. 3. As shown in FIG. 5, the method 500 includes one or more operations 502, 504, and 506. According to certain embodiments, the operations of the method 500 may be performed as a subroutine of the method 400 depicted in FIG. 4.

At operation 502, the location module 308 provisions a geo-fence based, wherein the geo-fence comprises a boundary.

In some embodiments, the boundary of the geo-fence may be based on a set of predefined user preferences associated with a user profile of the first client device 102. For example, a user of the client device 102 may define the boundary based on a threshold distance. In some embodiments, the boundary of the geo-fence may be configured by an administrator of the AR costume system 124.

In some embodiments, the geo-fence may be generated based on a location of the first client device 102, such that the geo-fence comprises a boundary with the first client device 102 as its central point. Accordingly, in such embodiments the geo-fence “moves” with the first client device 102.

At operation 504, the location module 308 detects a second client device 102 within the boundary of the geo-fence. For example, based on location data from the second client device 102, the location module 308 may determine that the second client device 102 is within the geo-fence.

At operation 506, responsive to detecting the second client device 102 within the boundary of the geo-fence, the AR module 306 accesses AR content from a user profile associated with the second client device 102. For example, the AR content may include an AR costume, or skin, to be applied to a display of an object (i.e., a person) corresponding to the second client device 102. Accordingly, the AR content may comprise an identification of a set of image features, wherein the set of image features correspond with one or more nodes of the AR content, such that the AR module 306 may display the AR content within a presentation of image data based on positions of the set of image features.

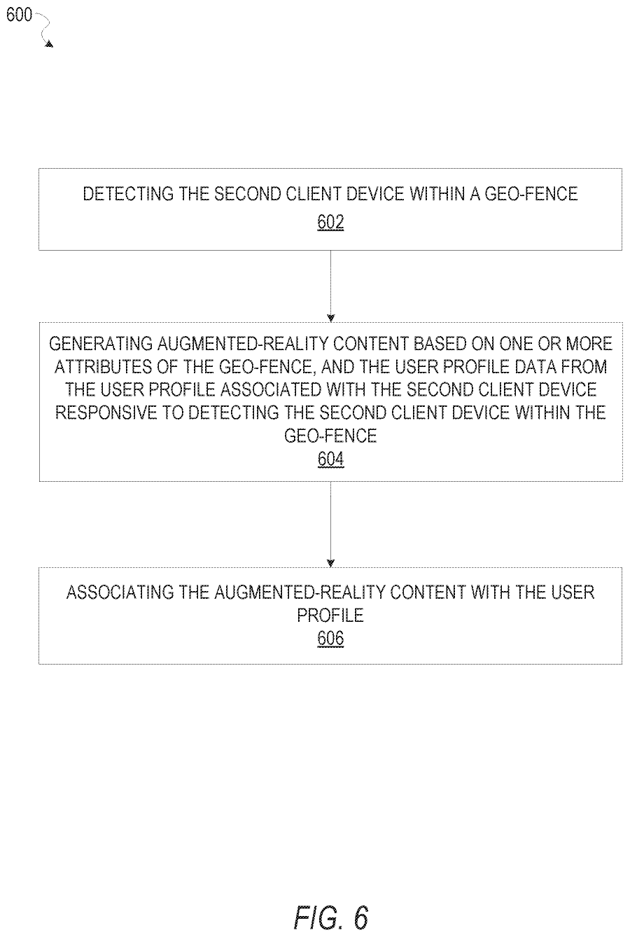

FIG. 6 is a flowchart illustrating a method 600 for generating AR content, according to certain example embodiments. Operations of the method 600 may be performed by the modules described above with respect to FIG. 3. As shown in FIG. 6, the method 600 includes one or more operations 602, 604, and 606. According to certain embodiments, the operations of the method 600 may be performed as a subroutine of the methods 400 and 500 depicted in FIGS. 4 and 5.

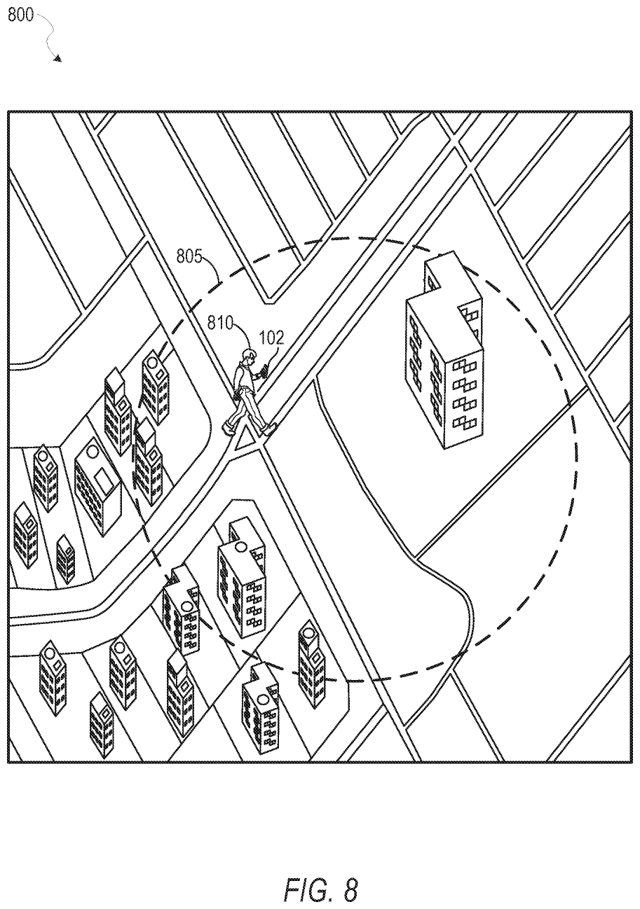

At operation 602, the location module 308 detects a second client device 102 within a boundary of a geo-fence, such as the geo-fence 805 of FIG. 8.

Responsive to detecting the second client device 102 within the boundary of the geo-fence, the AR module 306 generates AR content. In some embodiments, the AR content may be generated based on user profile data associated with the second client device 102, and one or more attributes associated with the geo-fence.

For example, the user profile data may comprise user attributes and user preferences that define attributes of AR content. Similarly, the geo-fence may itself be associated with one or more AR content attributes that correspond with the user preferences and user attributes. For example, responsive to detecting the second client device 102 within the geo-fence, the AR module 306 accesses the user profile associated with the second client device and retrieves a plurality of user attributes.

The AR module 306 may then access a media repository associated with the geo-fence, where the media repository comprises a collection of AR content attributes correlated with the user attributes. The AR module 306 may then generate the AR content for the user profile associated with the second client device 102 based on the user attributes. At operation 606, the AR module 306 associates the AR content with the user profile associated with the second client device 102.

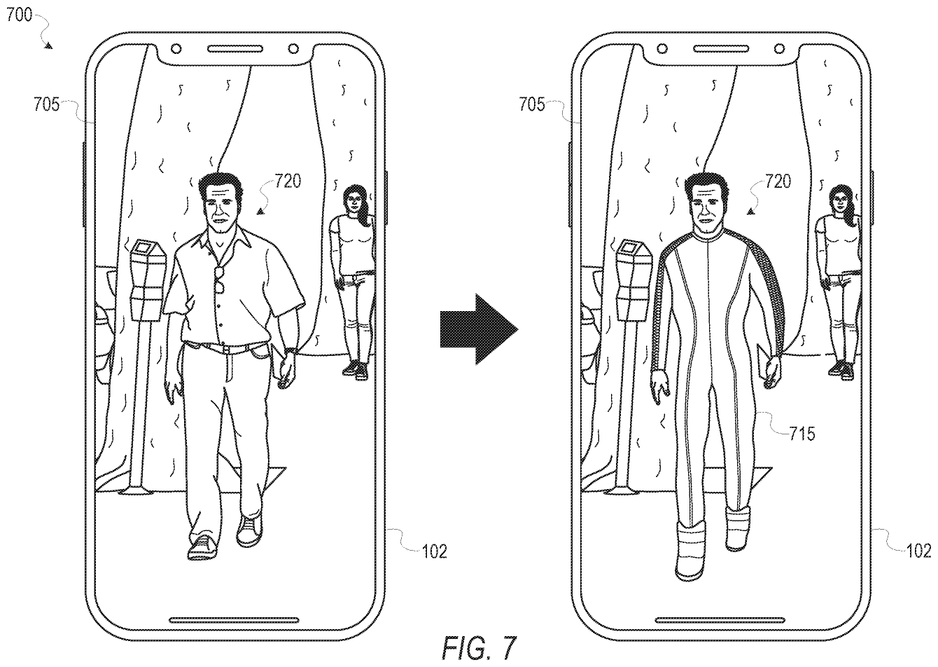

FIG. 7 is a diagram 700 illustrating AR content 715 presented in an interface according to the methods 400, 500, and 600 depicted in FIGS. 4, 5, and 6, and according to certain example embodiments.

As discussed in operation 402 of the method 400, the image module 302 of the AR costume system 124 causes display of a presentation of image data 705 at a first client device 102. The image data may comprise a data stream of image and video data captured by a camera associated with the first client device 102.

Responsive to causing display of the presentation of the image data 705 at the first client device 102, the machine-vision module 304 of the AR costume system 124 identifies a display of an object 720 at a position within the presentation of the image data 705 at the first client device 102. The detection of the object 720 may be based on one or more machine-vision, or object detection techniques. For example, the machine-vision module 304 may be configured to detect objects based on image features of the objects.

The machine-vision module 304 identifies a user account associated with the object 720 based on the image features (i.e., facial recognition), or based on location data received from a second client device, wherein the user account comprises an identification of AR content 715, or a set of user attributes and user preferences which may be used by the AR module 306 to generate and present the AR content 715.

For example, a user account associated with a second client device 102, wherein the second client device 102 corresponds with the object 720, may include an identification of the AR content 715 (i.e., based on a user selection of the AR content 715). As seen in FIG. 7, the AR content 715 may include a costume to be applied to a display of the user (i.e., the object 720) within the presentation of the image data 705 at the first client device 102.

FIG. 8 is a diagram 800 depicting a geo-fenced region 805, according to certain example embodiments. As discussed above, in certain embodiments the operations of the AR costume system 124 may be made available to users located within the geo-fenced region 805, such as the user 810. For example, as long as the user 810 is located within the geo-fenced region 805, the AR costume system 124 may detect locations of other client devices 102 located within the geo-fence 805 in order to identify displays of users associated with the client devices 102 in a presentation of image data at the client device 102 associated with the user 810.

### Software Architecture

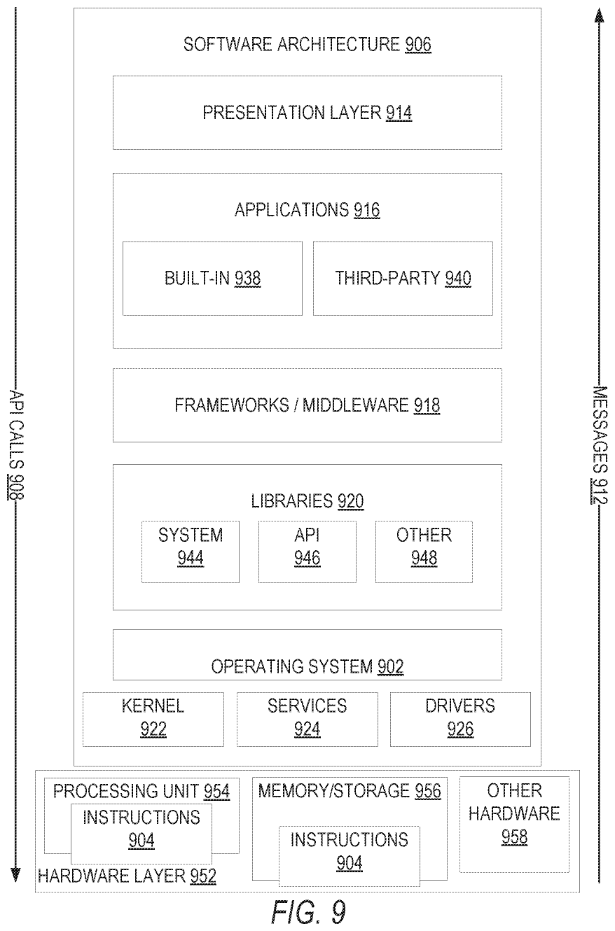

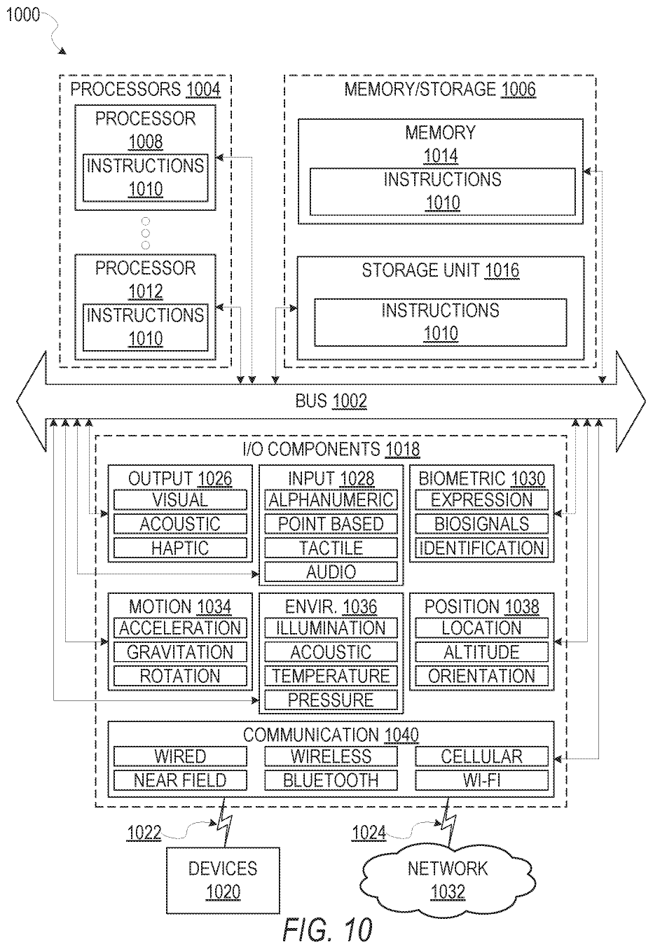

FIG. 9 is a block diagram illustrating an example software architecture 906, which may be used in conjunction with various hardware architectures herein described. FIG. 9 is a non-limiting example of a software architecture and it will be appreciated that many other architectures may be implemented to facilitate the functionality described herein. The software architecture 906 may execute on hardware such as the machine 1000 of FIG. 10 that includes, among other things, processors 1004, memory 1014, and I/O components 1018. A representative hardware layer 952 is illustrated and can represent, for example, the machine 900 of FIG. 9. The representative hardware layer 952 includes a processing unit 954 having associated executable instructions 904. Executable instructions 904 represent the executable instructions of the software architecture 906, including implementation of the methods, components and so forth described herein. The hardware layer 952 also includes memory and/or storage modules memory/storage 956, which also have executable instructions 904. The hardware layer 952 may also comprise other hardware 958.

In the example architecture of FIG. 9, the software architecture 906 may be conceptualized as a stack of layers where each layer provides particular functionality. For example, the software architecture 906 may include layers such as an operating system 902, libraries 920, applications 916 and a presentation layer 914. Operationally, the applications 916 and/or other components within the layers may invoke application programming interface (API) API calls 908 through the software stack and receive a response as in response to the API calls 908. The layers illustrated are representative in nature and not all software architectures have all layers. For example, some mobile or special purpose operating systems may not provide a frameworks/middleware 918, while others may provide such a layer. Other software architectures may include additional or different layers.

The operating system 902 may manage hardware resources and provide common services. The operating system 902 may include, for example, a kernel 922, services 924 and drivers 926. The kernel 922 may act as an abstraction layer between the hardware and the other software layers. For example, the kernel 922 may be responsible for memory management, processor management (e.g., scheduling), component management, networking, security settings, and so on. The services 924 may provide other common services for the other software layers. The drivers 926 are responsible for controlling or interfacing with the underlying hardware. For instance, the drivers 926 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 920 provide a common infrastructure that is used by the applications 916 and/or other components and/or layers. The libraries 920 provide functionality that allows other software components to perform tasks in an easier fashion than to interface directly with the underlying operating system 902 functionality (e.g., kernel 922, services 924 and/or drivers 926). The libraries 920 may include system libraries 944 (e.g., C standard library) that may provide functions such as memory allocation functions, string manipulation functions, mathematical functions, and the like. In addition, the libraries 920 may include API libraries 946 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 920 may also include a wide variety of other libraries 948 to provide many other APIs to the applications 916 and other software components/modules.

The frameworks/middleware 918 (also sometimes referred to as middleware) provide a higher-level common infrastructure that may be used by the applications 916 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 916 and/or other software components/modules, some of which may be specific to a particular operating system 902 or platform.

The applications 916 include built-in applications 938 and/or third-party applications 940. Examples of representative built-in applications 938 may include, but are not limited to, a contacts application, a browser application, a book reader application, a location application, a media application, a messaging application, and/or a game application. Third-party applications 940 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 940 may invoke the API calls 908 provided by the mobile operating system (such as operating system 902) to facilitate functionality described herein.

The applications 916 may use built in operating system functions (e.g., kernel 922, services 924 and/or drivers 926), libraries 920, and frameworks/middleware 918 to create user interfaces to interact with users of the system. Alternatively, or additionally, in some systems interactions with a user may occur through a presentation layer, such as presentation layer 914. In these systems, the application/component “logic” can be separated from the aspects of the application/component that interact with a user.

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein may be executed. As such, the instructions 1010 may be used to implement modules or components described herein. The instructions 1010 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1010, sequentially or otherwise, that specify actions to be taken by machine 1000. Further, while only a single machine 1000 is illustrated, the term “machine” shall also be taken to include a collection of machines that individually or jointly execute the instructions 1010 to perform any one or more of the methodologies discussed herein.

The machine 1000 may include processors 1004, memory memory/storage 1006, and I/O components 1018, which may be configured to communicate with each other such as via a bus 1002. The memory/storage 1006 may include a memory 1014, such as a main memory, or other memory storage, and a storage unit 1016, both accessible to the processors 1004 such as via the bus 1002. The storage unit 1016 and memory 1014 store the instructions 1010 embodying any one or more of the methodologies or functions described herein. The instructions 1010 may also reside, completely or partially, within the memory 1014, within the storage unit 1016, within at least one of the processors 1004 (e.g., within the processor's cache memory), or any suitable combination thereof, during execution thereof by the machine 1000. Accordingly, the memory 1014, the storage unit 1016, and the memory of processors 1004 are examples of machine-readable media.

The I/O components 1018 may include a wide variety of components to receive input, provide output, produce output, transmit information, exchange information, capture measurements, and so on. The specific I/O components 1018 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1018 may include many other components that are not shown in FIG. 10. The I/O components 1018 are grouped according to functionality merely for simplifying the following discussion and the grouping is in no way limiting. In various example embodiments, the I/O components 1018 may include output components 1026 and input components 1028. The output components 1026 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1028 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1018 may include biometric components 1030, motion components 1034, environmental environment components 1036, or position components 1038 among a wide array of other components. For example, the biometric components 1030 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1034 may include acceleration sensor components (e.g., accelerometer), gravitation sensor components, rotation sensor components (e.g., gyroscope), and so forth. The environment components 1036 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1018 may include communication components 1040 operable to couple the machine 1000 to a network 1032 or devices 1020 via coupling 1022 and coupling 1024 respectively. For example, the communication components 1040 may include a network interface component or other suitable device to interface with the network 1032. In further examples, communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1020 may be another machine or any of a wide variety of peripheral devices (e.g., a peripheral device coupled via a Universal Serial Bus (USB)).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EMPHEMERAL MESSAGE” in this context refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”. “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

1. A method comprising:
causing display of a presentation of image data that depicts a location at a first client device;
detecting a second client device in proximity of the first client device based on location data from the second client device, the second client device associated with a user profile that comprises user profile data that defines a user attribute associates with a user of the second client device;
identifying a display of an object at a position within the presentation of the image data based on the location data from the second client device, the display of the object comprising image features;
accessing the user profile data from the user profile associated with the second client device;
accessing a set of conditions associated with the location, the set of conditions including a correlation of augmented-reality content to the user profile data;
selecting the augmented-reality content from a collection of augmented-reality content based on the correlation; and
presenting the augmented-reality content within the presentation of the image data at the first client device based on the position of the object within the presentation of the image data.

2. The method of claim 1, wherein the presenting the augmented-reality content within the presentation of the image data at the first client device includes:
applying the augmented-reality content to the display of the object within the presentation of the image data based on at least the image features of the display of the object.

3. The method of claim 1, wherein the detecting the second client device in proximity of the first client device includes:
provisioning a geo-fence based on a location of the first client device, the geo-fence comprising a boundary; and
detecting the second client device within the boundary of the geo-fence.

4. The method of claim 1, wherein the accessing the user profile data from the user profile associated with the second client device includes:
identifying the user profile based on the image features of the object; and
accessing the user profile data from the user profile associated with the second client device in response to the identifying the user profile based on the image features of the object.

5. The method of claim 1, wherein the method further comprises:
generating the augmented-reality content of the user profile based on the location data from the second client device; and
associating the augmented-reality content with the user profile.

6. The method of claim 1, wherein the augmented-reality content includes an augmented-reality digital costume.

7. The method of claim 1, wherein the object includes a person.

8. A non-transitory machine-readable storage medium comprising instructions that, when executed by one or more processors of a machine, cause the machine to perform operations comprising:
causing display of a presentation of image data at a first client device;
detecting a second client device in proximity of the first client device based on location data from the second client device, the second client device associated with a user profile that comprises user profile data that defines a user attribute associates with a user of the second client device;
identifying a display of an object at a position within the presentation of the image data based on the location data from the second client device, the display of the object comprising image features;
accessing the user profile data from the user profile associated with the second client device;
accessing a set of conditions associated with the location, the set of conditions including a correlation of augmented-reality content to the user profile data;
selecting the augmented-reality content from a collection of augmented-reality content based on the correlation; and
presenting the augmented-reality content within the presentation of the image data at the first client device based on the position of the object within the presentation of the image data.

9. The non-transitory machine-readable storage medium of claim 8, wherein the presenting the augmented-reality content within the presentation of the image data at the first client device includes:
applying the augmented-reality content to the display of the object within the presentation of the image data based on at least the image features of the display of the object.

10. The non-transitory machine-readable storage medium of claim 8, wherein the detecting the second client device in proximity of the first client device includes:
provisioning a geo-fence based on a location of the first client device, the geo-fence comprising a boundary; and
detecting the second client device within the boundary of the geo-fence.

11. The non-transitory machine-readable storage medium of claim 10, wherein the accessing the user profile data from the user profile associated with the second client device includes:
identifying the user profile based on the image features of the object; and
accessing the user profile data from the user profile associated with the second client device in response to the identifying the user profile based on the image features of the object.

12. The non-transitory machine-readable storage medium of claim 10, wherein the operations further comprise:
generating the augmented-reality content of the user profile based on the location data from the second client device; and
associating the augmented-reality content with the user profile.

13. The non-transitory machine-readable storage medium of claim 10, wherein the augmented-reality content includes an augmented-reality digital costume.

14. The non-transitory machine-readable storage medium of claim 10, wherein the object includes a person.

15. A system comprising:
a memory; and
at least one hardware processor coupled to the memory and comprising instructions that causes the system to perform operations comprising:
causing display of a presentation of image data at a first client device;
detecting a second client device in proximity of the first client device based on location data from the second client device, the second client device associated with a user profile that comprises user profile data that defines a user attribute associates with a user of the second client device;
identifying a display of an object at a position within the presentation of the image data based on the location data from the second client device, the display of the object comprising image features;
accessing the user profile data from the user profile associated with the second client device;
accessing a set of conditions associated with the location, the set of conditions including a correlation of augmented-reality content to the user profile data;
selecting the augmented-reality content from a collection of augmented-reality content based on the correlation; and
presenting the augmented-reality content within the presentation of the image data at the first client device based on the position of the object within the presentation of the image data.

16. The system of claim 15, wherein the presenting the augmented-reality content within the presentation of the image data at the first client device includes:
applying the augmented-reality content to the display of the object within the presentation of the image data based on at least the image features of the display of the object.

17. The system of claim 15, wherein the detecting the second client device in proximity of the first client device includes:
provisioning a geo-fence based on a location of the first client device, the geo-fence comprising a boundary; and
detecting the second client device within the boundary of the geo-fence.

18. The system of claim 15, wherein the accessing the user profile data from the user profile associated with the second client device includes:
identifying the user profile based on the image features of the object; and
accessing the user profile data from the user profile associated with the second client device in response to the identifying the user profile based on the image features of the object.

19. The system of claim 15, wherein the operations further comprise:
generating the augmented-reality content of the user profile based on the location data from the second client device; and
associating the augmented-reality content with the user profile.

20. The system of claim 15, wherein the augmented-reality content includes an augmented-reality digital costume.
